(19) United States
(12) Patent Application Publication
(10) Pub. No.: US 2026/0289823 A1
(43) Pub. Date: Sep. 24, 2026

(54) PARTITIONING METHOD FOR POINT CLOUD ATTRIBUTE CODING

(71) Applicant: InterDigital VC Holdings, Inc., Wilmington, DE (US)

(72) Inventors: Jiahao Pang, Plainsboro, NJ (US); Junghyun Ahn, New York, NY (US); Dong Tian, Boxborough, MA (US)

(21) Appl. No.: 19/085,781

(22) Filed: Mar. 20, 2025

(51) Int. Cl. G06T 9/00; H04N 19/119; H04N 19/174; H04N 19/70

(52) U.S. Cl. CPC G06T 9/001; H04N 19/119; H04N 19/174; H04N 19/70

(57) ABSTRACT

Some embodiments of a method may include: obtaining a first slicing scheme for a point cloud geometry; decoding one or more point cloud geometry slices; assembling the one or more point cloud geometry slices into a reconstructed point cloud geometry; obtaining a second slicing scheme for a point cloud attribute; slicing the reconstructed point cloud geometry according to the second slicing scheme; decoding one or more point cloud attribute slices, wherein decoding the one or more point cloud attribute slices comprises decoding a point cloud attribute slice for each of the one or more point cloud geometry slices; and assembling the one or more point cloud attribute slices into a decoded attribute point cloud.

### INCORPORATION BY REFERENCE

The present application incorporates by reference in their entirety the following applications: U.S. Non-Provisional patent application Ser. No. 19/083,252, entitled “CODING ORDER CONTROL METHOD FOR LOSSLESS POINT CLOUD COMPRESSION” and filed Mar. 18, 2025 (“252 application”); U.S. Non-Provisional patent application Ser. No. 18/830,379, entitled “VOXEL-WISE CODING CONTROL METHOD FOR LOSSLESS POINT CLOUD COMPRESSION” and filed Sep. 10, 2024 (“379 application”); U.S. Non-Provisional patent application Ser. No. 18/829,989, entitled “END-TO-END LEARNING-BASED DYNAMIC POINT CLOUD ATTRIBUTE CODING FRAMEWORK” and filed Sep. 10, 2024 (“989 application”); U.S. Non-Provisional patent application Ser. No. 18/814,402, entitled “END-TO-END LEARNING-BASED POINT CLOUD ATTRIBUTE CODING FRAMEWORK” and filed Aug. 23, 2024 (“402 application”); U.S. Non-Provisional patent application Ser. No. 18/814,400, entitled “LEARNING-BASED POINT CLOUD GEOMETRY COMPRESSION FRAMEWORK” and filed Aug. 23, 2024 (“400 application”); and U.S. Non-Provisional patent application Ser. No. 18/784,466, entitled “END-TO-END LEARNING-BASED DYNAMIC POINT CLOUD CODING FRAMEWORK” and filed Jul. 25, 2024 (“466 application”).

### BACKGROUND

The present application is related to point cloud compression.

### SUMMARY

A first example method in accordance with some embodiments may include: obtaining a first slicing scheme for a point cloud geometry; decoding one or more point cloud geometry slices; assembling the one or more point cloud geometry slices into a reconstructed point cloud geometry; obtaining a second slicing scheme for a point cloud attribute; slicing the reconstructed point cloud geometry according to the second slicing scheme; decoding one or more point cloud attribute slices, wherein decoding the one or more point cloud attribute slices includes decoding a point cloud attribute slice for each of the one or more point cloud geometry slices; and assembling the one or more point cloud attribute slices into a decoded attribute point cloud.

For some embodiments of the first example method, obtaining the second slicing scheme includes obtaining a slice quantity value, wherein the slice quantity value indicates how many slices to slice the reconstructed point cloud geometry.

For some embodiments of the first example method, slicing the reconstructed point cloud geometry includes performing an iterative slicing process on the reconstructed point cloud based on the slice quantity value.

For some embodiments of the first example method, the slice quantity value is greater than 8.

For some embodiments of the first example method, obtaining the second slicing scheme for the point cloud attribute includes obtaining an attribute bitstream, wherein the attribute bitstream includes the point cloud attribute.

Some embodiments of the first example method may further include obtaining a geometry bitstream, wherein the geometry bitstream includes the point cloud geometry.

A second example method in accordance with some embodiments may include: obtaining a first slicing scheme for a point cloud geometry; encoding one or more point cloud geometry slices; assembling the one or more point cloud geometry slices into a reconstructed point cloud geometry; recoloring the reconstructed point cloud geometry according to an input point cloud attribute, wherein recoloring the reconstructed point cloud generates a reconstructed point cloud with attribute; slicing the reconstructed point cloud with attribute into one or more point cloud attribute slices; and encoding the one or more point cloud attribute slices.

For some embodiments of the second example method, slicing the reconstructed point cloud with attribute includes: determining variance values of the reconstructed point cloud with attribute along x, y, and z axes; selecting one or more of the x, y, and z axes based on size of the respective variance values; estimating a partitioning boundary of the reconstructed point cloud with attribute for each of the selected axes; and partitioning the reconstructed point cloud with attribute into slices along the selected axes at each of the estimated partitioning boundaries.

For some embodiments of the second example method, selecting one or more of the x, y, and z axes selects axes with a corresponding variance value above a threshold.

For some embodiments of the second example method, estimating the partition boundary includes estimating the partition boundary as a boundary that splits the reconstructed point cloud with attribute into two groups with approximately equal numbers of points for each of the two groups.

For some embodiments of the second example method, partitioning the reconstructed point cloud with attribute into slices partitions the reconstructed point cloud with attribute into a power of 2 number of slices.

Some embodiments of the second example method may further include sending the estimated partitioning boundaries to a decoding device.

Some embodiments of the second example method may further include slicing the point cloud geometry into one or more point cloud geometry slices.

Some embodiments of the second example method may further include obtaining a slice quantity value, wherein the slice quantity value indicates how many slices to slice the reconstructed point cloud with attribute.

For some embodiments of the second example method, slicing the reconstructed point cloud with attribute includes performing an iterative slicing process on the reconstructed point cloud with attribute based on the slice quantity value.

For some embodiments of the second example method, the slice quantity value is greater than 8.

Some embodiments of the second example method may further include generating a geometry bitstream, wherein the geometry bitstream includes the encoded one or more point cloud geometry slices.

For some embodiments of the second example method, the geometry bitstream includes the first slicing scheme.

Some embodiments of the second example method may further include generating an attribute bitstream, wherein the attribute bitstream includes the encoded one or more point cloud attribute slices.

A second example apparatus in accordance with some embodiments may include: a processor; and a memory storing instructions operative, when executed by the processor, to cause the apparatus to: obtain a first slicing scheme for a point cloud geometry; encode one or more point cloud geometry slices; assemble the one or more point cloud geometry slices into a reconstructed point cloud geometry; recolor the reconstructed point cloud geometry according to an input point cloud attribute, wherein recoloring the reconstructed point cloud generates a reconstructed point cloud with attribute; slice the reconstructed point cloud with attribute into one or more point cloud attribute slices; and encode the one or more point cloud attribute slices.

### BRIEF DESCRIPTION OF THE DRAWINGS

The following detailed description will be better understood when read in conjunction with the appended drawings, in which there are shown examples of one or more of the multiple embodiments of the present application. It should be understood, however, that the embodiments described herein are not limited to the precise arrangements and instrumentalities shown in the drawings. In the drawings:

FIG. 1 is a system diagram illustrating an example set of interfaces for a system according to some embodiments.

FIG. 2 is a process diagram illustrating an example same slicing for geometry and attribute coding process according to some embodiments.

FIG. 3 is a process diagram illustrating an example point cloud slicing process according to some embodiments.

FIG. 4 is a process diagram illustrating an example different slicing for geometry and attribute coding encoder process according to some embodiments.

FIG. 5 is a process diagram illustrating an example different slicing for geometry and attribute coding decoder process according to some embodiments.

FIG. 6 is a flowchart illustrating an example process for point cloud slicing according to some embodiments.

FIG. 7 is a flowchart illustrating an example process for decoding a point cloud frame according to some embodiments.

FIG. 8 is a flowchart illustrating an example process for encoding a current point cloud frame according to some embodiments.

The entities, connections, arrangements, and the like that are depicted in—and described in connection with—the various figures are presented by way of example and not by way of limitation. As such, any and all statements or other indications as to what a particular figure “depicts,” what a particular element or entity in a particular figure “is” or “has,” and any and all similar statements—that may in isolation and out of context be read as absolute and therefore limiting—may only properly be read as being constructively preceded by a clause such as “In at least one embodiment, . . . ” For brevity and clarity of presentation, this implied leading clause is not repeated ad nauseum in the detailed description.

### DETAILED DESCRIPTION

In describing the various embodiments of the present application, certain terminology is used herein for convenience only and should not be considered as limiting such embodiments. In the drawings, the same reference numerals are employed for designating the same elements throughout the several figures and the present description.

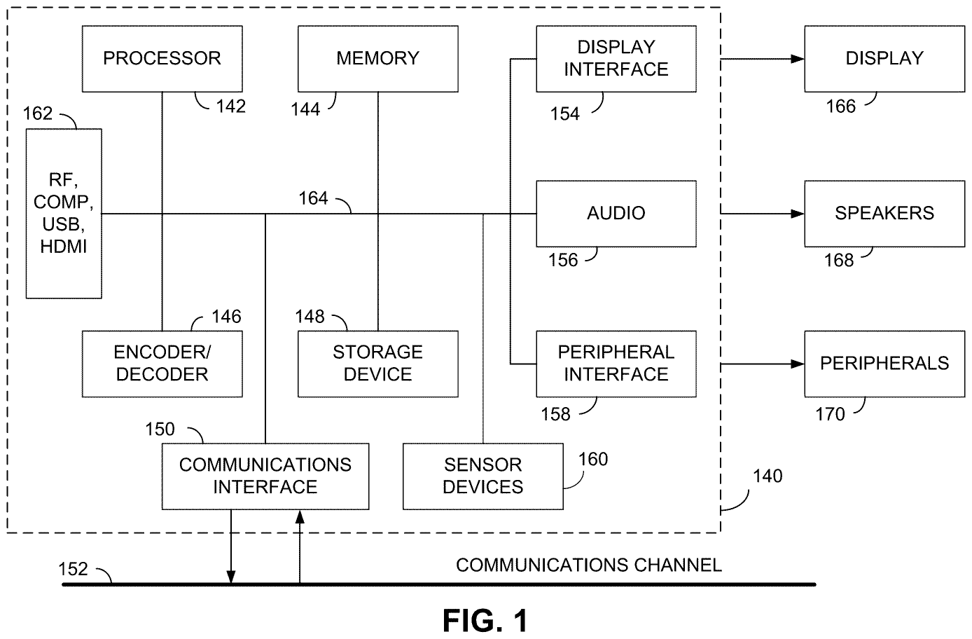

FIG. 1 is a system diagram illustrating an example set of interfaces for a system according to some embodiments. An extended reality display device, together with its control electronics, may be implemented using a system such as the system of FIG. 1. System 140 can be embodied as a device including the various components described below and is configured to perform one or more of the aspects described in this document. Examples of such devices, include, but are not limited to, various electronic devices such as personal computers, laptop computers, smartphones, tablet computers, digital multimedia set top boxes, digital television receivers, personal video recording systems, connected home appliances, and servers. Elements of system 140, singly or in combination, can be embodied in a single integrated circuit (IC), multiple ICs, and/or discrete components. For example, in at least one embodiment, the processing and encoder/decoder elements of system 140 are distributed across multiple ICs and/or discrete components. In various embodiments, the system 140 is communicatively coupled to one or more other systems, or other electronic devices, via, for example, a communications bus or through dedicated input and/or output ports. In various embodiments, the system 140 is configured to implement one or more of the aspects described in this document.

The system 140 includes at least one processor 142 configured to execute instructions loaded therein for implementing, for example, the various aspects described in this document. Processor 142 may include embedded memory, input output interface, and various other circuitries as known in the art. The system 140 includes at least one memory 144 (e.g., a volatile memory device, and/or a non-volatile memory device). System 140 may include a storage device 148, which can include non-volatile memory and/or volatile memory, including, but not limited to, Electrically Erasable Programmable Read-Only Memory (EEPROM), Read-Only Memory (ROM), Programmable Read-Only Memory (PROM), Random Access Memory (RAM), Dynamic Random Access Memory (DRAM), Static Random Access Memory (SRAM), flash, magnetic disk drive, and/or optical disk drive. The storage device 148 can include an internal storage device, an attached storage device (including detachable and non-detachable storage devices), and/or a network accessible storage device, as non-limiting examples.

System 140 includes an encoder/decoder module 146 configured, for example, to process data to provide an encoded video or decoded video, and the encoder/decoder module 146 can include its own processor and memory. The encoder/decoder module 146 represents module(s) that can be included in a device to perform the encoding and/or decoding functions. As is known, a device can include one or both of the encoding and decoding modules. Additionally, encoder/decoder module 146 can be implemented as a separate element of system 140 or can be incorporated within processor 142 as a combination of hardware and software as known to those skilled in the art.

Program code to be loaded onto processor 142 or encoder/decoder 146 to perform the various aspects described in this document can be stored in storage device 148 and subsequently loaded onto memory 144 for execution by processor 142. In accordance with various embodiments, one or more of processor 142, memory 144, storage device 148, and encoder/decoder module 146 can store one or more of various items during the performance of the processes described in this document. Such stored items can include, but are not limited to, the input video, the decoded video or portions of the decoded video, the bitstream, matrices, variables, and intermediate or final results from the processing of equations, formulas, operations, and operational logic.

In some embodiments, memory inside of the processor 142 and/or the encoder/decoder module 146 is used to store instructions and to provide working memory for processing that is needed during encoding or decoding. In other embodiments, however, a memory external to the processing device (for example, the processing device can be either the processor 142 or the encoder/decoder module 142) is used for one or more of these functions. The external memory can be the memory 144 and/or the storage device 148, for example, a dynamic volatile memory and/or a non-volatile flash memory. In several embodiments, an external non-volatile flash memory is used to store the operating system of, for example, a television. In at least one embodiment, a fast external dynamic volatile memory such as a RAM is used as working memory for video coding and decoding operations, such as for MPEG-2 (MPEG refers to the Moving Picture Experts Group, MPEG-2 is also referred to as ISO/IEC 13818, and 13818-1 is also known as H.222, and 13818-2 is also known as H.262), HEVC (HEVC refers to High Efficiency Video Coding, also known as H.265 and MPEG-H Part 2), or VVC (Versatile Video Coding, a new standard being developed by JVET, the Joint Video Experts Team).

The input to the elements of system 140 can be provided through various input devices as indicated in block 162. Such input devices include, but are not limited to, (i) a radio frequency (RF) portion that receives an RF signal transmitted, for example, over the air by a broadcaster, (ii) a Component (COMP) input terminal (or a set of COMP input terminals), (iii) a Universal Serial Bus (USB) input terminal, and/or (iv) a High Definition Multimedia Interface (HDMI) input terminal. Other examples, not shown in FIG. 1, include composite video.

In various embodiments, the input devices of block 162 have associated respective input processing elements as known in the art. For example, the RF portion can be associated with elements suitable for (i) selecting a desired frequency (also referred to as selecting a signal, or band-limiting a signal to a band of frequencies), (ii) downconverting the selected signal, (iii) band-limiting again to a narrower band of frequencies to select (for example) a signal frequency band which can be referred to as a channel in certain embodiments, (iv) demodulating the downconverted and band-limited signal, (v) performing error correction, and (vi) demultiplexing to select the desired stream of data packets. The RF portion of various embodiments includes one or more elements to perform these functions, for example, frequency selectors, signal selectors, band-limiters, channel selectors, filters, downconverters, demodulators, error correctors, and demultiplexers. The RF portion can include a tuner that performs various of these functions, including, for example, downconverting the received signal to a lower frequency (for example, an intermediate frequency or a near-baseband frequency) or to baseband. In one set-top box embodiment, the RF portion and its associated input processing element receives an RF signal transmitted over a wired (for example, cable) medium, and performs frequency selection by filtering, downconverting, and filtering again to a desired frequency band. Various embodiments rearrange the order of the above-described (and other) elements, remove some of these elements, and/or add other elements performing similar or different functions. Adding elements can include inserting elements in between existing elements, such as, for example, inserting amplifiers and an analog-to-digital converter. In various embodiments, the RF portion includes an antenna.

Additionally, the USB and/or HDMI terminals can include respective interface processors for connecting system 140 to other electronic devices across USB and/or HDMI connections. It is to be understood that various aspects of input processing, for example, Reed-Solomon error correction, can be implemented, for example, within a separate input processing IC or within processor 142 as necessary. Similarly, aspects of USB or HDMI interface processing can be implemented within separate interface ICs or within processor 142 as necessary. The demodulated, error corrected, and demultiplexed stream is provided to various processing elements, including, for example, processor 142, and encoder/decoder 146 operating in combination with the memory and storage elements to process the datastream as necessary for presentation on an output device.

Various elements of system 140 can be provided within an integrated housing, Within the integrated housing, the various elements can be interconnected and transmit data therebetween using suitable connection arrangement 164, for example, an internal bus as known in the art, including the Inter-IC (12C) bus, wiring, and printed circuit boards.

The system 140 includes communication interface 150 that enables communication with other devices via communication channel 152. The communication interface 150 can include, but is not limited to, a transceiver configured to transmit and to receive data over communication channel 152. The communication interface 150 can include, but is not limited to, a modem or network card and the communication channel 152 can be implemented, for example, within a wired and/or a wireless medium.

Data is streamed, or otherwise provided, to the system 140, in various embodiments, using a wireless network such as a Wi-Fi network, for example IEEE 802.11 (IEEE refers to the Institute of Electrical and Electronics Engineers). The Wi-Fi signal of these embodiments is received over the communications channel 152 and the communications interface 150 which are adapted for Wi-Fi communications. The communications channel 152 of these embodiments is typically connected to an access point or router that provides access to external networks including the Internet for allowing streaming applications and other over-the-top communications. Other embodiments provide streamed data to the system 140 using a set-top box that delivers the data over the HDMI connection of the input block 162. Still other embodiments provide streamed data to the system 140 using the RF connection of the input block 162. As indicated above, various embodiments provide data in a non-streaming manner. Additionally, various embodiments use wireless networks other than Wi-Fi, for example a cellular network or a Bluetooth network.

The system 140 can provide an output signal to various output devices, including a display 166, speakers 168, and other peripheral devices 170. The display 166 of various embodiments includes one or more of, for example, a touchscreen display, an organic light-emitting diode (OLED) display, a curved display, and/or a foldable display. The display 166 can be for a television, a tablet, a laptop, a cell phone (mobile phone), or other device. The display 166 can also be integrated with other components (for example, as in a smart phone), or separate (for example, an external monitor for a laptop). The other peripheral devices 170 include, in various examples of embodiments, one or more of a stand-alone digital video disc (or digital versatile disc) (DVR, for both terms), a disk player, a stereo system, and/or a lighting system. Various embodiments use one or more peripheral devices 170 that provide a function based on the output of the system 140. For example, a disk player performs the function of playing the output of the system 140.

In various embodiments, control signals are communicated between the system 140 and the display 166, speakers 168, or other peripheral devices 170 using signaling such as AV.Link, Consumer Electronics Control (CEC), or other communications protocols that enable device-to-device control with or without user intervention. The output devices can be communicatively coupled to system 140 via dedicated connections through respective interfaces 154, 156, and 158. Alternatively, the output devices can be connected to system 140 using the communications channel 152 via the communications interface 150. The display 166 and speakers 168 can be integrated in a single unit with the other components of system 140 in an electronic device such as, for example, a television. In various embodiments, the display interface 154 includes a display driver, such as, for example, a timing controller (T Con) chip.

The display 166 and speaker 168 can alternatively be separate from one or more of the other components, for example, if the RF portion of input 162 is part of a separate set-top box. In various embodiments in which the display 166 and speakers 168 are external components, the output signal can be provided via dedicated output connections, including, for example, HDMI ports, USB ports, or COMP outputs.

The system 140 may include one or more sensor devices 160. Examples of sensor devices that may be used include one or more GPS sensors, gyroscopic sensors, accelerometers, light sensors, cameras, depth cameras, microphones, and/or magnetometers. Such sensors may be used to determine information such as user's position and orientation. Where the system 140 is used as the control module for an extended reality display (such as control modules), the user's position and orientation may be used in determining how to render image data such that the user perceives the correct portion of a virtual object or virtual scene from the correct point of view. In the case of head-mounted display devices, the position and orientation of the device itself may be used to determine the position and orientation of the user for the purpose of rendering virtual content. In the case of other display devices, such as a phone, a tablet, a computer monitor, or a television, other inputs may be used to determine the position and orientation of the user for the purpose of rendering content. For example, a user may select and/or adjust a desired viewpoint and/or viewing direction with the use of a touch screen, keypad or keyboard, trackball, joystick, or other input. Where the display device has sensors such as accelerometers and/or gyroscopes, the viewpoint and orientation used for the purpose of rendering content may be selected and/or adjusted based on motion of the display device.

The embodiments can be carried out by computer software implemented by the processor 142 or by hardware, or by a combination of hardware and software. As a non-limiting example, the embodiments can be implemented by one or more integrated circuits. The memory 144 can be of any type appropriate to the technical environment and can be implemented using any appropriate data storage technology, such as optical memory devices, magnetic memory devices, semiconductor-based memory devices, fixed memory, and removable memory, as non-limiting examples. The processor 142 can be of any type appropriate to the technical environment, and can encompass one or more of microprocessors, general purpose computers, special purpose computers, and processors based on a multi-core architecture, as non-limiting examples.

A User Equipment (UE) may correspond to any extended Reality (XR) device/node which may come in variety of form factors. Typical UE (e.g., XR UE) may include, but not limited to the following: Head Mounted Displays (HMD), optical see-through glasses and video see-through HMDs for Augmented Reality (AR) and Mixed Reality (MR), mobile devices with positional tracking and camera, wearables etc. In addition to the above, several different types of XR UE may be envisioned based on XR device functions for e.g., as display, camera, sensors, sensor processing, wireless connectivity, XR/Media processing, and power supply, to be provided by one or more devices, wearables, actuators, controllers and/or accessories. One or more device/nodes/UEs may be grouped into a collaborative XR group for supporting any of XR applications/experience/services.

### Point Cloud Data Format

The field of point cloud compression and processing aims to develop tools for compression, analysis, interpolation, representation, and understanding of point cloud signals.

Point cloud data is a universal data format used across several business domains from autonomous driving, robotics, AR/VR, civil engineering, computer graphics, to the animation/movie industry. 3D LiDAR sensors have been deployed in self-driving cars, and affordable LiDAR sensors are released from Velodyne Velabit, Apple iPad Pro 2020, and Intel RealSense LiDAR camera L515. With advances in sensing technologies, 3D point cloud data becomes more practical than ever.

Point cloud data is also believed to consume a large portion of network traffic, e.g., among connected cars over 5G network, and immersive communications (VR/AR). Efficient representation formats may be necessary for point cloud understanding and communication. In particular, raw point cloud data may be organized and processed for the purposes of world modeling and sensing. Compression on raw point clouds may be used when storage and transmission of the data are used in related scenarios.

Furthermore, point clouds may represent a sequential scan of the same scene, which contains multiple moving objects. They are called dynamic point clouds, while static point clouds may be captured from a static scene or static objects. Dynamic point clouds are typically organized into frames, with different frames being captured at different times. Dynamic point clouds may require the processing and compression to be handled in real-time or with low delay.

Each point of the point clouds may be represented at least by a 3D position (x, y, z). The set of 3D positions illustrates the geometry of the object/scene from which the point cloud is captured. Additionally, each point of the point cloud may be associated with some attributes, depending on the applications. For example, for VR/AR/Gaming, the attribute may include color (r, g, b); and for LiDAR, the attribute may include reflectance.

### Point Cloud Data Use Cases

The automotive industry and autonomous cars are domains in which point clouds may be used. Autonomous cars are able to “probe” their environment to make good driving decisions based on the reality of their immediate surroundings. Typical sensors, like LiDARs, produce (dynamic) point clouds that are used by the perception engine. These point clouds are not intended to be viewed by human eyes, and they are typically sparse, not necessarily colored, and dynamic with a high frequency of capture. They may have other attributes, like the reflectance ratio provided by the LiDAR because this attribute may be indicative of the material of the sensed object, and this attribute may be used in making a decision.

Virtual Reality (VR) and immersive worlds have become a hot topic and are foreseen by many as the future of 2D flat video. The viewer is immersed in an environment all around the viewer, while in standard TV, the viewer may look at the virtual world in front of the viewer. There are several gradations in the immersivity depending on the freedom of the viewer in the environment. Point clouds are a good format candidate to distribute VR worlds. They may be static or dynamic and are typically of average size, with, e.g., no more than millions of points at a time.

Point clouds also may be used for various purposes, such as culture heritage/buildings in which objects, like statues or buildings, are scanned in 3D to share the spatial configuration of the object without sending or visiting the statues or buildings. Also, point clouds offer a way to ensure preservation of knowledge of the object in case the original object, for instance, is destroyed by an earthquake. Such point clouds are typically static, colored, and huge.

Another use case is in topography and cartography in which, when using 3D representations, maps are not limited to the plane and may include the relief. Google Maps is a good example of 3D maps but is understood to use meshes instead of point clouds. Nevertheless, point clouds may be a suitable data format for 3D maps, and such point clouds are typically static, colored, and huge.

World modeling and sensing via point clouds may be a technology that allows machines to gain knowledge about the 3D world around them, which may be used by the applications discussed above.

3D point cloud data includes discrete samples on the surfaces of objects or scenes. A huge number of points may be used to fully represent the real world with point samples. For instance, a typical VR immersive scene may contain millions of points, while point clouds typically contain hundreds of millions of points. Therefore, the processing of such large-scale point clouds may be computationally expensive, especially for consumer devices, such as smartphones, tablets, and automotive navigation systems, that have limited computational power.

The first step for processing or inference on a point cloud is to have efficient storage methodologies. To store and process the input point cloud with affordable computational cost, the point cloud may be down-sampled first, in which the down-sampled point cloud summarizes the geometry of the input point cloud while having much fewer points. The down-sampled point cloud may be inputted into a machine task for further processing. However, further reduction in storage space may be achieved by converting the raw point cloud data (original or down-sampled) into a bitstream through entropy coding techniques for lossless compression.

In addition to lossless coding, many scenarios seek use lossy coding for significantly improved compression ratios while maintaining the induced distortion under certain quality levels. To achieve a less lossy coding, an efficient point feature extractor may be used to improve the accuracy of the reconstruction within the given resource budget.

The present application presents various ways to partition a point cloud frame into slices for encoding and decoding purposes. The point cloud attribute may be partitioned into smaller slices than point cloud geometry. In this way, the learning-based point cloud codec may be run on hardware with less memory and may allow more optimization of the coding performance for point cloud encoding.

### Learning-Based Point Cloud Attribute Compression

Since point cloud data is composed of two components: geometry info and attribute info, the compression of point clouds may be classified into two categories: geometry coding and attribute coding. Point cloud geometry is defined by the 3D position of each point. Point attributes are the additional information associated with each point. Example of point cloud attributes include RGB color for VR/AR point clouds and reflectance for LiDAR point clouds.

To encode or decode a point cloud frame, often the point cloud frame is partitioned into a few slices. For some embodiments, partitioning may be beneficial to: fit the encoding or decoding process into a resource limited hardware or platform; support spatial random access; favor coding efficiencies; and boost parallel encoding or decoding.

Point clouds may impose great challenges when being stored or transmitted due to a huge amount of data. This challenge may be due to the coding of both point cloud geometry and point cloud attribute information. The present application attempts to tackle the challenges in learning-based point cloud attribute compression. The present application discusses how to partition a point cloud attribute frame into slices when using deep learning techniques for the coding of point cloud attribute(s).

Partitioning Point Cloud Geometry into Slices

According to TMAP v1 for AI-Based Point Cloud Coding, MPEG WG07, w24853 (January 2025), the hybrid codec, MPEG AI-PCC codec TMAPv1, is composed of a learning-based point cloud geometry codec and a RAHT-based (non-learning-based) point cloud attribute codec.

A point cloud geometry frame is partitioned into slices prior to encoding. The point cloud geometry encoding is performed independently for each slice from a current point cloud geometry frame. On the decoder side, after all slices from a current point cloud geometry frame are decoded, they are assembled to output the current point cloud geometry frame.

### Slicing

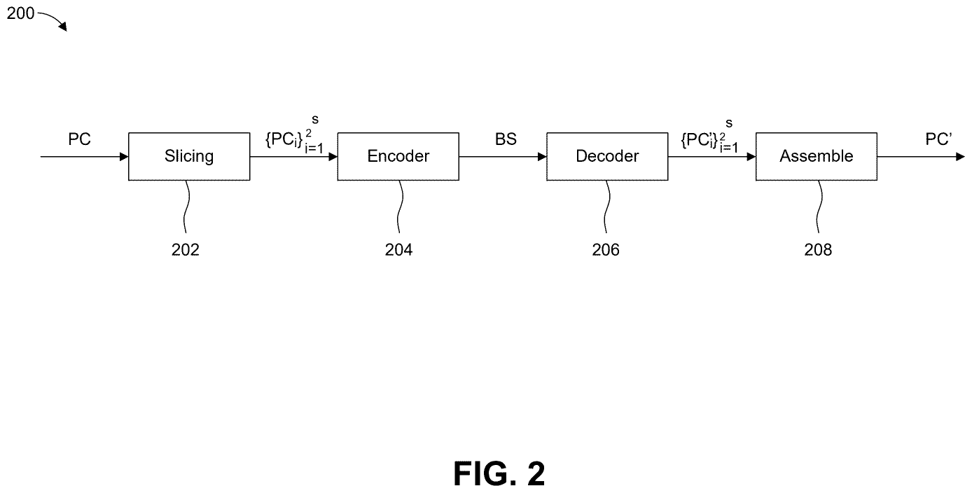

FIG. 2 is a process diagram illustrating an example same slicing for geometry and attribute coding process according to some embodiments. A point cloud geometry frame is partitioned into slices prior to encoding using a learning-based encoder. For some embodiments, as shown in the process 200 of FIG. 2, the same slice partitioning scheme (“Slicing” block 202 in FIG. 2) is applied before encoding the point cloud attribute. The sliced point cloud is then encoded into a bitstream by an encoder 204. On the decoder side, the bitstream is decoded by a decoder 206 into point cloud slices. An assembler 208 assembles the slices into a decoded point cloud. As shown in FIG. 2, the input point cloud is partitioned into 25 slices before encoding and assembling back after decoding. The parameter s is the slicing parameter indicating the desired number of slices.

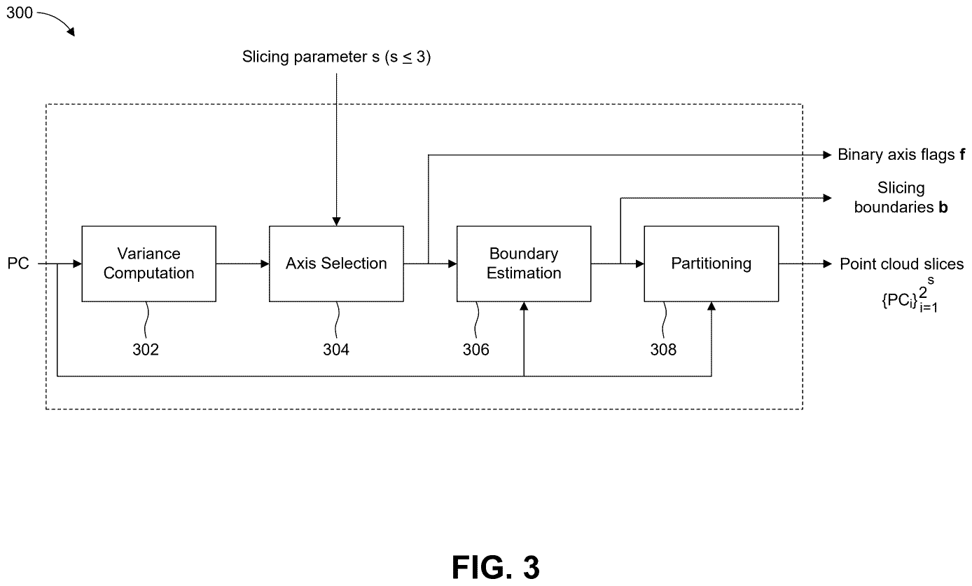

FIG. 3 is a process diagram illustrating an example point cloud slicing process according to some embodiments. A slice partitioning method (corresponding to the “Slicing” block in FIG. 2) for both point cloud geometry and attributes is shown in FIG. 3. Given an input point cloud (PC in FIG. 3) and a slicing parameter s≤3, the Elementary Point Cloud Slicing block aims at partitioning the input point cloud into 2^{s} slices. For some embodiments, the Elementary Point Cloud Slicing block consists of a few steps.

A point cloud (PC) is passed to a Variance Computation block 302. The Variance Computation block 302 computes the variance of the point cloud geometry along the x, y, and z axes, leading to 3 variance values: σₓ², σ_{y}², and σ_{z}².

According to the variance values, the Axis Selection block 304 picks s (0, 1, 2, or 3) axes. The Axis Selection block 304 picks s axes with the largest variance values. For instance, if s=0, then none of the axes will be picked. If s=1, then only one of the x, y, and z axes with largest variance will be picked. The Elementary Point Cloud Slicing block 300 partitions the input point cloud along these picked axes. A binary flag to indicate whether an axis is selected. There are three (3) binary flags, denoted fₓ, f_{y}, and f_{z}, corresponding to the x, y, and z axes, respectively. Together they form a vector f, the output of the Axis Selection block 304.

The Boundary Estimation block 306 estimates the partitioning boundary along each selected axis. The purpose of boundary estimation is to find a partitioning boundary along a given axis. When the point cloud is partitioned at the estimated boundary, the two partitions have a similar number of points. In other words, the two partitions will be approximately the same size, and the computation needed to code each partition is approximately the same. If the x axis is picked, then along the x axis, the Boundary Estimation block 306 computes the 50th percentile of the point cloud along the x axis. The 50th percentile value gives the slicing boundary bₓ along the x axis. If the x axis is not picked, the Boundary Estimation block 306 directly sets the slicing boundary bₓ=0 to signal that this axis is not picked and no partition boundary is computed. This process repeats for all axes, and all the boundaries together form a vector b. In the special case where s=0, the Boundary Estimation block 306 outputs b=[0, 0, 0].

The Partitioning block 308 partitions the input point cloud into several slices. The Partitioning block 308 takes as inputs the point cloud (PC) and the slicing boundaries b. The Partitioning block 308 partitions the input into 2^{s} slices along the selected axes at the estimated boundaries. The partitioned 2^{s} point cloud slices, {PCᵢ}ᵢ₌₁²^{_{S}}, are output by the Partitioning block 308.

The overall output of the Elementary point cloud slicing block 300 consists of f, b, and the partitioned slices, {PCᵢ}ᵢ₌₁²^{_{S}}.

In some embodiments, the slice partitioning is signaled in the high-level slice configuration syntax shown in Table 1.

TABLE 1

| Structure | Descriptor Data Type |
|---|---|
| structure slice_configuration( ) | |
| { | |
| binary_axis_flag[3] | u(1) |
| slicing_boundary[3] | u(24) |
| } | |

The semantics of the syntax elements in Table 1 are provided below. The elements binary_axis_flag and slicing_boundary together form the structure slice_configuration( ).

Element “binary_axis_flag” specifies binary axis selection flags f.

Element “slicing_boundary” specifies the partitioning boundary along the x, y, and the z axes b.

The structure slice_configuration( ) is part of the sequence level parameter set, which is part of the sequence level parameter set shown in Table 2.

TABLE 2

| Structure | Descriptor Data Type |
|---|---|
| structure seq_sps( ) | |
| { | |
| slice | u(8) |
| slice_configuration( ) | |
| } | |

The semantics of the syntax elements in Table 2 are shown below.

Element “slice” specifies the slicing parameter s.

After the decoder is signaled with the slice partitioning information, all point cloud slices are assembled into a point cloud frame. This functionality is achieved by the Point Cloud Assembling block (“Assemble” block in FIG. 2). The Point Cloud Assembling block concatenates all decoded point clouds slices into a decoded point cloud for output.

### Deeper Slice Embodiment

Different from the previous configuration, where the point cloud attribute shares the same slice structure as the point cloud geometry, the point cloud may be partitioned into smaller slices for point cloud attributes than the slices for point cloud geometry.

This configuration is at least motivated by the larger memory required to encode/decode point cloud attributes compared to the point cloud geometry. For example, in an octree representation of a point cloud geometry, a binary flag is enough to represent the geometry because an octree voxel is either occupied or empty. However, an integer number with 8-bit or more bits may be required for each RGB color channel.

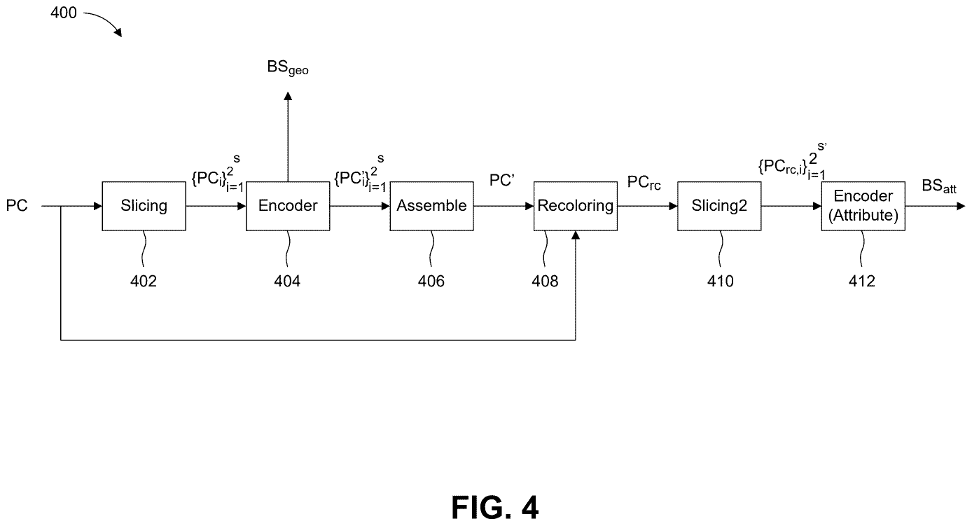

FIG. 4 is a process diagram illustrating an example different slicing for geometry and attribute coding encoder process according to some embodiments.

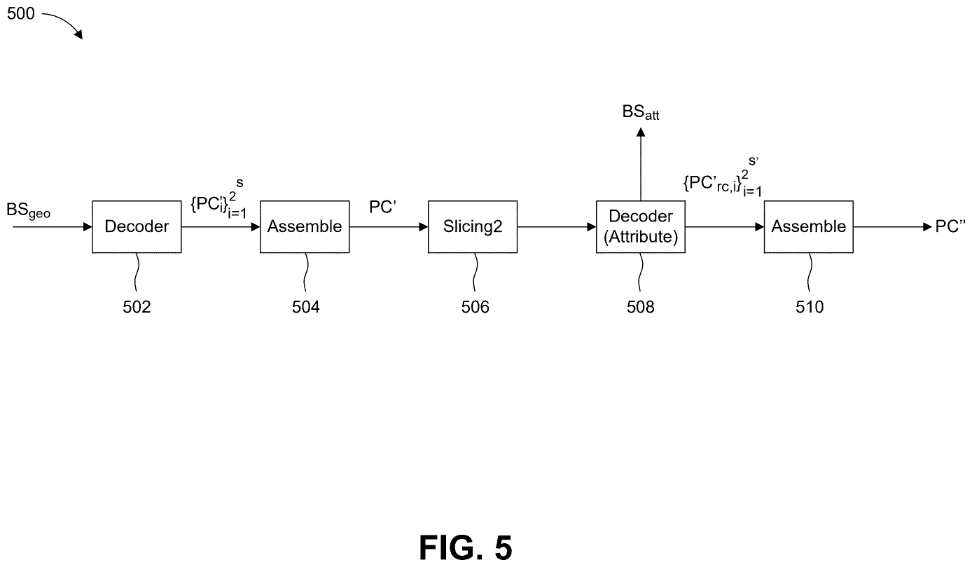

FIGS. 4 and 5 show how to use different slicing structures for geometry and for attribute on the encoder side and the decoder side, respectively. For the encoder method 400 of FIG. 4, the geometry of a point cloud (“PC”) is partitioned into 2^{s} slices by the Slicing block 402. The slices are encoded into a bitstream BS_{geo} by an Encoder block 404. The encoded output represents the geometry. The encoder 404 also outputs the reconstructed point cloud slices, {PCᵢ′}ᵢ₌₁²^{_{S}}. The slices are assembled into a reconstructed point cloud PC′ (with geometry only) by the Assemble block 406.

The attributes from the input (“PC”) are transferred onto the reconstructed point cloud geometry PC′ by the Recoloring block 408. Another slicing block 410 (“Slice2”) partitions the recolored point cloud PC_{rc} into 2^{s}′ slices. Note that s and s′ may be different. For attribute coding, typically s′≥s.

The point cloud slices are encoded with the encoder 412, and the output is the attribute bitstream, BSₐₜₜ.

FIG. 5 is a process diagram illustrating an example different slicing for geometry and attribute coding decoder process according to some embodiments. For the decoder method 500 of FIG. 5, the geometry bitstream BS_{geo} is decoded into 2^{s} point cloud slices

$${\{ P {C}_{i}^{′} \}}_{i = 1}^{{2}^{s}}$$

by the Decoder block 502. The decoded slices are assembled into the reconstructed geometry PC′ by the Assemble block 504.

The “Slice2” block 506 slices the geometry data into 2^{s}′ slices. The attribute bitstream BSₐₜₜ is decoded by the Decoder block 508. The decoded attribute slices are attached to the decoded point cloud geometry slices, leading to 2^{s}′ point cloud slices with attributes,

$${\{ P {C}_{rc , i}^{′} \}}_{i = 1}^{{2}^{s ′}} .$$

The point cloud slices

$${\{ P {C}_{rc , i}^{′} \}}_{i = 1}^{{2}^{s ′}}$$

are assembled into the decoded point cloud PC″ by the Assemble block 510.

For slicing the point cloud into more than 8 partitions (“Slicing2” block 506 in FIG. 5), the Elementary Point Cloud Slicing block introduced earlier may be insufficient. The Elementary Point Cloud Slicing block only supports up to 8 slices (s≤3). As a result, a Point Cloud Slicing block that supports arbitrary slicing parameters s is introduced.

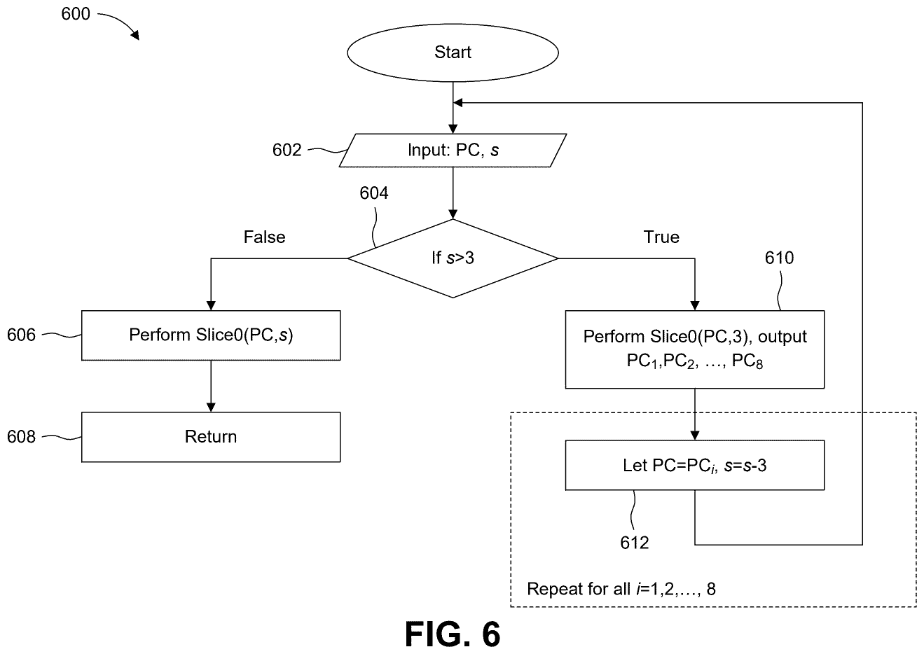

FIG. 6 is a flowchart illustrating an example process for point cloud slicing according to some embodiments. The flowchart of the Point Cloud Slicing block is provided in FIG. 6. In this process 600, a point cloud (PC) and a parameter s are obtained 602 as inputs. A determination 604 is made to determine if s is greater than 3.

If s is not greater than 3, then the “Perform Slice0 (PC, s)” block 606 views the Elementary Point Cloud Slicing block as a function “Slice0” that slices a point cloud “PC” for slicing parameter s≤3. For some embodiments, the Point Cloud Slicing block is defined on top of the Elementary Point Cloud Slicing block by using the Elementary Point Cloud Slicing block in a recursive manner. Upon finishing the recursive loop, the process returns 608.

If the slicing parameter s>3, the Point Cloud Slicing block launches the “Perform Slice0(PC, 3)” block 610 followed by subtracting 3 from s. In the recursive process block 612, s=s−3 and PC=PCᵢ for all i=1, 2, . . . 8. Such a process is applied recursively until the slicing parameter s≤3 and the “Perform Slice0(PC, s)” block 606 is launched.

In some embodiments, the Elementary Point Cloud Slicing block is used for geometry coding (“Slicing” block in FIG. 4), while the Point Cloud Slicing block is used for attribute coding (“Slicing2” in FIG. 4 and FIG. 5). In this case, the high-level syntax is updated as shown in the slice configuration syntax for attribute coding of Table 3 and the sequence level parameter set syntax for attribute coding of Table 4.

TABLE 3

| Structure | Descriptor Data Type |
|---|---|
| structure slice_configuration_attr( ) | |
| { | |
| binary_axis_flag[n] | u(1) |
| slicing_boundary[n] | u(24) |
| } | |

TABLE 4

| Structure | Descriptor Data Type |
|---|---|
| structure seq_sps( ) | |
| { | |
| slice | u(8) |
| slice_attr | u(8) |
| slice_configuration( ) | |
| slice_configuration_attr( ) | |
| } | |

The semantics of the additional syntax elements of Table 4 are shown below.

The element “slice_attr” specifies the slicing parameter s for attribute coding.

Additionally, n in Table 3 is the total number of slicing boundaries (for binary axis flags) output in the slicing process. The relationship between n and s is given by

$$n = \frac{3}{7} ( {2}^{3 ⌈ s / 3 ⌉} - 1 ) ,$$

in which ┌⋅┐ denotes a ceiling operator. In practice, picking an s≤6 is sufficient, so n will be at most 27 in practical use cases for some embodiments.

After the decoder is signaled with the slice partitioning information, the decoder assembles all point cloud slices into a point cloud frame. This functionality is achieved by the Point Cloud Assembling block. The Point Cloud Assembling block concatenates all the decoded point clouds slices into the decoded point cloud for output.

### OTHER EMBODIMENTS

In some embodiments, the number of slices in geometry coding and the number of slices in attribute coding may be configured separately. However, both the geometry coding and the attribute coding use the Point Cloud Slicing block in FIG. 6. In other words, both “Slicing” and “Slicing2” in FIGS. 4 and 5 are implemented with Point Cloud Slicing block in FIG. 6. Therefore, for some embodiments, the geometry coding also may use a slicing parameter that is more than 3, but less than the slicing parameter of attribute coding, e.g., the slicing parameter of attribute coding may be 5.

In some embodiments, the number of slices in geometry coding and the number of slices in attribute coding are configured separately. However, both the geometry coding and the attribute coding use the Elementary Point Cloud Slicing block in FIG. 3. In other words, both “Slicing” and “Slicing2” in FIG. 4 and FIG. 5 are implemented with Elementary Point Cloud Slicing block in FIG. 3. Therefore, for some embodiments, attribute coding ensures the slicing parameter is not larger than 3, but no less than the slicing parameter of geometry coding. For example, the slicing parameter for attribute coding may be 2 while the slicing parameter of geometry coding may be 1.

By partitioning the point cloud into more slices, the coding of each slice consumes less memory and the whole coding process may fit into a device with less memory. However, by having more slices, the coding performance may become worse because the coding of each slice is performed independently, and the codec cannot capture the correlation of the information across partition boundaries.

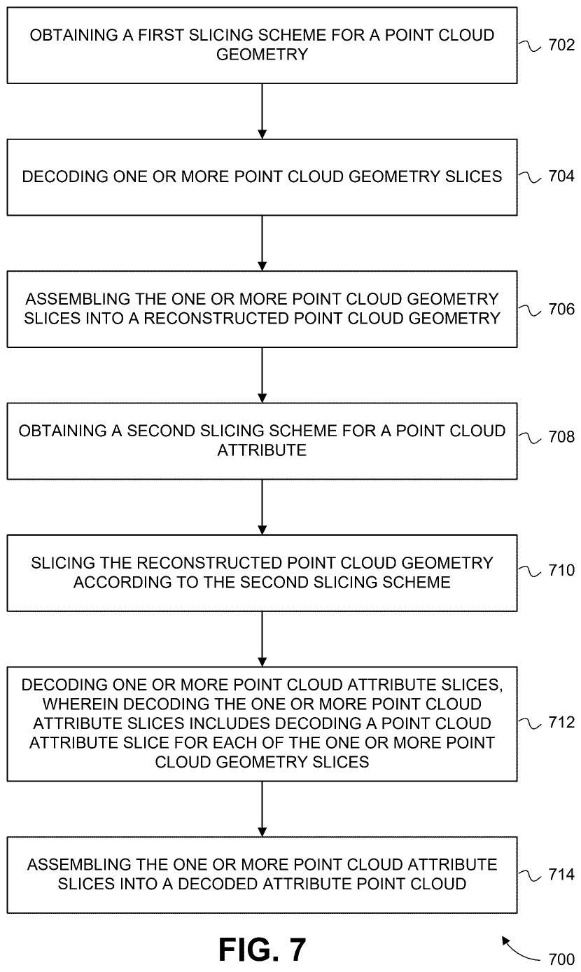

FIG. 7 is a flowchart illustrating an example process for decoding a point cloud frame according to some embodiments. For some embodiments, an example process 700 may include obtaining 702 a first slicing scheme for a point cloud geometry. For some embodiments, the example process 700 may further include decoding 704 one or more point cloud geometry slices. For some embodiments, the example process 700 may further include assembling 706 the one or more point cloud geometry slices into a reconstructed point cloud geometry. For some embodiments, the example process 700 may further include obtaining 708 a second slicing scheme for a point cloud attribute. For some embodiments, the example process 700 may further include slicing 710 the reconstructed point cloud geometry according to the second slicing scheme. For some embodiments, the example process 700 may further include decoding 712 one or more point cloud attribute slices, wherein decoding the one or more point cloud attribute slices includes decoding a point cloud attribute slice for each of the one or more point cloud geometry slices. For some embodiments, the example process 700 may further include assembling 714 the one or more point cloud attribute slices into a decoded attribute point cloud.

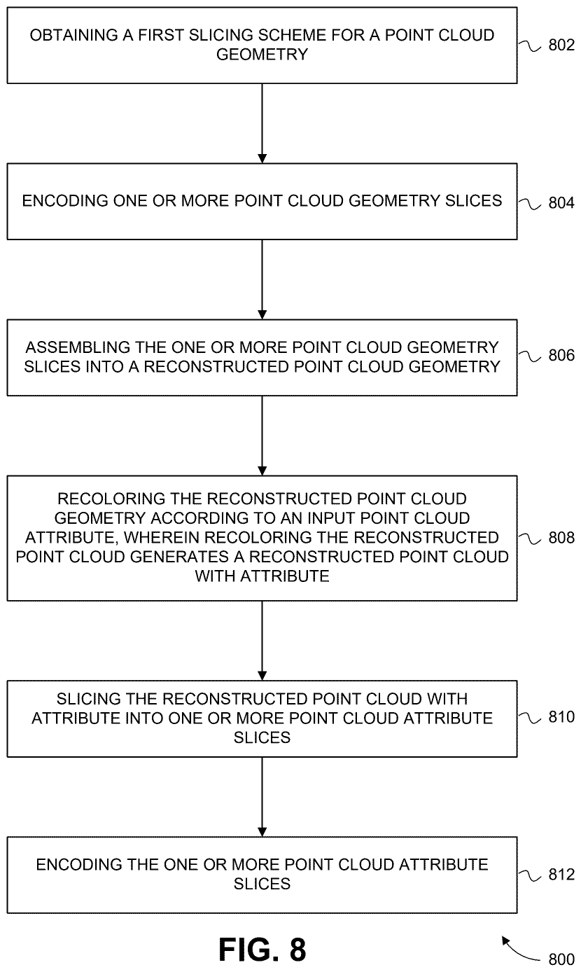

FIG. 8 is a flowchart illustrating an example process for encoding a current point cloud frame according to some embodiments. For some embodiments, an example process 800 may include obtaining 802 a first slicing scheme for a point cloud geometry. For some embodiments, the example process 800 may further include encoding 804 one or more point cloud geometry slices. For some embodiments, the example process 800 may further include assembling 806 the one or more point cloud geometry slices into a reconstructed point cloud geometry. For some embodiments, the example process 800 may further include recoloring 808 the reconstructed point cloud geometry according to an input point cloud attribute, wherein recoloring the reconstructed point cloud generates a reconstructed point cloud with attribute. For some embodiments, the example process 800 may further include slicing 810 the reconstructed point cloud with attribute into one or more point cloud attribute slices. For some embodiments, the example process 800 may further include encoding 812 the one or more point cloud attribute slices.

An example apparatus in accordance with some embodiments may include at least one processor configured to perform any one of the methods described within this application. An example apparatus in accordance with some embodiments may include a computer-readable medium storing instructions for causing one or more processors to perform any one of the methods described within this application. An example apparatus in accordance with some embodiments may include at least one processor and at least one non-transitory computer-readable medium storing instructions for causing the at least one processor to perform any one of the methods described within this application. An example signal in accordance with some embodiments may include a bitstream generated according to any one of the methods described within this application.

While the methods and systems in accordance with some embodiments are generally discussed in context of extended reality (XR), some embodiments may be applied to any XR contexts such as, e.g., virtual reality (VR)/mixed reality (MR)/augmented reality (AR) contexts. Also, although the term “head mounted display (HMD)” is used herein in accordance with some embodiments, some embodiments may be applied to a wearable device (which may or may not be attached to the head) capable of, e.g., XR, VR, AR, and/or MR for some embodiments.

A first example method in accordance with some embodiments may include: obtaining a first slicing scheme for a point cloud geometry; decoding one or more point cloud geometry slices; assembling the one or more point cloud geometry slices into a reconstructed point cloud geometry; obtaining a second slicing scheme for a point cloud attribute; slicing the reconstructed point cloud geometry according to the second slicing scheme; decoding one or more point cloud attribute slices, wherein decoding the one or more point cloud attribute slices includes decoding a point cloud attribute slice for each of the one or more point cloud geometry slices; and assembling the one or more point cloud attribute slices into a decoded attribute point cloud.

For some embodiments of the first example method, obtaining the second slicing scheme includes obtaining a slice quantity value, wherein the slice quantity value indicates how many slices to slice the reconstructed point cloud geometry.

For some embodiments of the first example method, slicing the reconstructed point cloud geometry includes performing an iterative slicing process on the reconstructed point cloud based on the slice quantity value.

For some embodiments of the first example method, the slice quantity value is greater than 8.

For some embodiments of the first example method, obtaining the second slicing scheme for the point cloud attribute includes obtaining an attribute bitstream, wherein the attribute bitstream includes the point cloud attribute.

Some embodiments of the first example method may further include obtaining a geometry bitstream, wherein the geometry bitstream includes the point cloud geometry.

A second example method in accordance with some embodiments may include: obtaining a first slicing scheme for a point cloud geometry; encoding one or more point cloud geometry slices; assembling the one or more point cloud geometry slices into a reconstructed point cloud geometry; recoloring the reconstructed point cloud geometry according to an input point cloud attribute, wherein recoloring the reconstructed point cloud generates a reconstructed point cloud with attribute; slicing the reconstructed point cloud with attribute into one or more point cloud attribute slices; and encoding the one or more point cloud attribute slices.

For some embodiments of the second example method, slicing the reconstructed point cloud with attribute includes: determining variance values of the reconstructed point cloud with attribute along x, y, and z axes; selecting one or more of the x, y, and z axes based on size of the respective variance values; estimating a partitioning boundary of the reconstructed point cloud with attribute for each of the selected axes; and partitioning the reconstructed point cloud with attribute into slices along the selected axes at each of the estimated partitioning boundaries.

For some embodiments of the second example method, selecting one or more of the x, y, and z axes selects axes with a corresponding variance value above a threshold.

For some embodiments of the second example method, estimating the partition boundary includes estimating the partition boundary as a boundary that splits the reconstructed point cloud with attribute into two groups with approximately equal numbers of points for each of the two groups.

For some embodiments of the second example method, partitioning the reconstructed point cloud with attribute into slices partitions the reconstructed point cloud with attribute into a power of 2 number of slices.

Some embodiments of the second example method may further include sending the estimated partitioning boundaries to a decoding device.

Some embodiments of the second example method may further include slicing the point cloud geometry into one or more point cloud geometry slices.

Some embodiments of the second example method may further include obtaining a slice quantity value, wherein the slice quantity value indicates how many slices to slice the reconstructed point cloud with attribute.

For some embodiments of the second example method, slicing the reconstructed point cloud with attribute includes performing an iterative slicing process on the reconstructed point cloud with attribute based on the slice quantity value.

For some embodiments of the second example method, the slice quantity value is greater than 8.

Some embodiments of the second example method may further include generating a geometry bitstream, wherein the geometry bitstream includes the encoded one or more point cloud geometry slices.

For some embodiments of the second example method, the geometry bitstream includes the first slicing scheme.

Some embodiments of the second example method may further include generating an attribute bitstream, wherein the attribute bitstream includes the encoded one or more point cloud attribute slices.

A second example apparatus in accordance with some embodiments may include: a processor; and a memory storing instructions operative, when executed by the processor, to cause the apparatus to: obtain a first slicing scheme for a point cloud geometry; encode one or more point cloud geometry slices; assemble the one or more point cloud geometry slices into a reconstructed point cloud geometry; recolor the reconstructed point cloud geometry according to an input point cloud attribute, wherein recoloring the reconstructed point cloud generates a reconstructed point cloud with attribute; slice the reconstructed point cloud with attribute into one or more point cloud attribute slices; and encode the one or more point cloud attribute slices.

One or more embodiments provide a computer program including instructions which when executed by one or more processors cause such processors to perform the encoding and/or decoding methods according to any of the embodiments described above. One or more embodiments also provide a computer readable storage medium having stored thereon instructions for encoding or decoding video data according to the methods described above.

One or more embodiments provide a computer readable storage medium having stored thereon video data generated according to the methods described above. One or more embodiments also provide a method and apparatus for transmitting or receiving video data generated according to the methods described above.

The embodiments described herein may be implemented in, for example, a method or a process, an apparatus, a software program, a data stream, or a signal. Even if only discussed in the context of a single form of implementation (e.g., as a method), the implementation of such features may also be implemented in other forms. An apparatus may be implemented in, for example, appropriate hardware, software, and firmware. Corresponding methods may be implemented in, for example, a processor.

Various numeric values are used in the present application. Such specific values are for example purposes and the embodiments described are not limited to these specific values.

Various methods are described herein, and such methods include one or more steps or actions for achieving the described method. Unless a specific order of steps or actions is required for the proper operation of the method, the order and/or use of specific steps and/or actions may be modified or combined. Additionally, terms such as “first”, “second”, etc. may be used in various embodiments to modify an element, component, step, operation, etc., for example, a “first decoding” and a “second decoding”. Use of such terms does not imply an order to the operations unless specifically required.

The present application may refer to “determining” various pieces of information. Determining information may include one or more of, for example, estimating, calculating, predicting, or retrieving (e.g., from memory) the information.

The present application may refer to “accessing” various pieces of information. Accessing information may include one or more of, for example, receiving, retrieving (e.g., from memory), storing, moving, copying, calculating, determining, predicting, or estimating the information. Similarly, the present application may refer to “receiving” various pieces of information. Receiving information may include one or more of, for example, accessing or retrieving (e.g., from memory) the information.

It is to be understood that use of any of the following “/”, “and/or”, and “at least one of” is intended to encompass all possible selections of listed items, taken either individually or in any combination thereof.

While specific embodiments have been described in the foregoing description in connection with the accompanying drawings, it should be understood that embodiments described herein are examples only and should not be taken as limiting the scope of the present application or the following claims. Although features and elements are described herein in particular combinations, those of ordinary skill in the art will appreciate that such features or elements may be used alone or in any combination with the other features and elements. It is understood, therefore, that the overall teachings of the present application are not limited to the particular embodiments, implementations, and examples disclosed herein, but are intended to cover variations, modifications, and alternatives as defined by the appended claims and any and all equivalents thereof.

This application describes a variety of aspects, including tools, features, embodiments, models, approaches, etc. Many of these aspects are described with specificity and, at least to show the individual characteristics, are often described in a manner that may sound limiting. However, this is for purposes of clarity in description, and does not limit the application or scope of those aspects. Indeed, all of the different aspects can be combined and interchanged to provide further aspects. Moreover, the aspects can be combined and interchanged with aspects described in earlier filings as well.

Various numeric values may be used in the present application, for example. The specific values are for example purposes and the aspects described are not limited to these specific values.

Embodiments described herein may be carried out by computer software implemented by a processor or other hardware, or by a combination of hardware and software. As a non-limiting example, the embodiments can be implemented by one or more integrated circuits. The processor can be of any type appropriate to the technical environment and can encompass one or more of microprocessors, general purpose computers, special purpose computers, and processors based on a multi-core architecture, as non-limiting examples.

When a figure is presented as a flow diagram, it should be understood that it also provides a block diagram of a corresponding apparatus. Similarly, when a figure is presented as a block diagram, it should be understood that it also provides a flow diagram of a corresponding method/process.

The implementations and aspects described herein can be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or program). An apparatus can be implemented in, for example, appropriate hardware, software, and firmware. The methods can be implemented in, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this application are not necessarily all referring to the same embodiment.

Additionally, this application may refer to “determining” various pieces of information. Determining the information can include one or more of, for example, estimating the information, calculating the information, predicting the information, or retrieving the information from memory.

Further, this application may refer to “accessing” various pieces of information. Accessing the information can include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving is, as with “accessing”, intended to be a broad term. Receiving the information can include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items as are listed.

Implementations can produce a variety of signals formatted to carry information that can be, for example, stored or transmitted. The information can include, for example, instructions for performing a method, or data produced by one of the described implementations. For example, a signal can be formatted to carry the bitstream of a described embodiment. Such a signal can be formatted, for example, as an electromagnetic wave (for example, using a radio frequency portion of spectrum) or as a baseband signal. The formatting can include, for example, encoding a data stream and modulating a carrier with the encoded data stream. The information that the signal carries can be, for example, analog or digital information. The signal can be transmitted over a variety of different wired or wireless links, as is known. The signal can be stored on a processor-readable medium.

Note that various hardware elements of one or more of the described embodiments are referred to as “modules” that carry out (i.e., perform, execute, and the like) various functions that are described herein in connection with the respective modules. As used herein, a module includes hardware (e.g., one or more processors, one or more microprocessors, one or more microcontrollers, one or more microchips, one or more application-specific integrated circuits (ASICs), one or more field programmable gate arrays (FPGAs), one or more memory devices) deemed suitable by those of skill in the relevant art for a given implementation. Each described module may also include instructions executable for carrying out the one or more functions described as being carried out by the respective module, and it is noted that those instructions could take the form of or include hardware (i.e., hardwired) instructions, firmware instructions, software instructions, and/or the like, and may be stored in any suitable non-transitory computer-readable medium or media, such as commonly referred to as RAM, ROM, etc.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method of decoding a point cloud frame, comprising:
obtaining a first slicing scheme for a point cloud geometry;
decoding one or more point cloud geometry slices;
assembling the one or more point cloud geometry slices into a reconstructed point cloud geometry;
obtaining a second slicing scheme for a point cloud attribute;
slicing the reconstructed point cloud geometry according to the second slicing scheme;
decoding one or more point cloud attribute slices,
wherein decoding the one or more point cloud attribute slices comprises decoding a point cloud attribute slice for each of the one or more point cloud geometry slices; and
assembling the one or more point cloud attribute slices into a decoded attribute point cloud.

2. The method of claim 1, wherein obtaining the second slicing scheme comprises:
obtaining a slice quantity value,
wherein the slice quantity value indicates how many slices to slice the reconstructed point cloud geometry.

3. The method of claim 2, wherein slicing the reconstructed point cloud geometry comprises performing an iterative slicing process on the reconstructed point cloud based on the slice quantity value.

4. The method of claim 2, wherein the slice quantity value is greater than 8.

5. The method of claim 1, wherein obtaining the second slicing scheme for the point cloud attribute comprises:
obtaining an attribute bitstream,
wherein the attribute bitstream comprises the point cloud attribute.

6. The method of claim 1, further comprising:
obtaining a geometry bitstream,
wherein the geometry bitstream comprises the point cloud geometry.

7. A method of encoding a current point cloud frame, comprising:
obtaining a first slicing scheme for a point cloud geometry;
encoding one or more point cloud geometry slices;
assembling the one or more point cloud geometry slices into a reconstructed point cloud geometry;
recoloring the reconstructed point cloud geometry according to an input point cloud attribute,
wherein recoloring the reconstructed point cloud generates a reconstructed point cloud with attribute;
slicing the reconstructed point cloud with attribute into one or more point cloud attribute slices; and
encoding the one or more point cloud attribute slices.

8. The method of claim 7, wherein slicing the reconstructed point cloud with attribute comprises:
determining variance values of the reconstructed point cloud with attribute along x, y, and z axes;
selecting one or more of the x, y, and z axes based on size of the respective variance values;
estimating a partitioning boundary of the reconstructed point cloud with attribute for each of the selected axes; and
partitioning the reconstructed point cloud with attribute into slices along the selected axes at each of the estimated partitioning boundaries.

9. The method of claim 8, wherein selecting one or more of the x, y, and z axes selects axes with a corresponding variance value above a threshold.

10. The method of claim 8, wherein estimating the partition boundary comprises estimating the partition boundary as a boundary that splits the reconstructed point cloud with attribute into two groups with approximately equal numbers of points for each of the two groups.

11. The method of claim 8, wherein partitioning the reconstructed point cloud with attribute into slices partitions the reconstructed point cloud with attribute into a power of 2 number of slices.

12. The method of claim 8, further comprising sending the estimated partitioning boundaries to a decoding device.

13. The method of claim 7, further comprising slicing the point cloud geometry into one or more point cloud geometry slices.

14. The method of claim 7, further comprising:
obtaining a slice quantity value,
wherein the slice quantity value indicates how many slices to slice the reconstructed point cloud with attribute.

15. The method of claim 14, wherein slicing the reconstructed point cloud with attribute comprises performing an iterative slicing process on the reconstructed point cloud with attribute based on the slice quantity value.

16. The method of claim 15, wherein the slice quantity value is greater than 8.

17. The method of claim 7, further comprising:
generating a geometry bitstream,
wherein the geometry bitstream comprises the encoded one or more point cloud geometry slices.

18. The method of claim 17, wherein the geometry bitstream comprises the first slicing scheme.

19. The method of claim 7, further comprising:
generating an attribute bitstream,
wherein the attribute bitstream comprises the encoded one or more point cloud attribute slices.

20. An apparatus comprising:
a processor; and
a memory storing instructions operative, when executed by the processor, to cause the apparatus to:
obtain a first slicing scheme for a point cloud geometry;
encode one or more point cloud geometry slices;
assemble the one or more point cloud geometry slices into a reconstructed point cloud geometry;
recolor the reconstructed point cloud geometry according to an input point cloud attribute,
wherein recoloring the reconstructed point cloud generates a reconstructed point cloud with attribute;
slice the reconstructed point cloud with attribute into one or more point cloud attribute slices; and
encode the one or more point cloud attribute slices.
